(19) United States
(12) Patent Application Publication
(10) Pub. No.: US 2018/0276880 A1
(43) Pub. Date: Sep. 27, 2018

(54) SYSTEM AND METHOD FOR RENDERING GEOSPATIAL MAPS

(71) Applicant: EarthX, Inc., San Francisco, CA (US)

(72) Inventors: Kyle VanderLugt, San Bruno, CA (US); Tom Gaskins, Seattle, WA (US)

(21) Appl. No.: 15/465,474

(22) Filed: Mar. 21, 2017

(51) Int. Cl. G06T 17/05; H04L 29/08; H04L 29/06; G06F 17/30; G06F 3/0484

(52) U.S. Cl. CPC G06T 17/05; H04L 67/306; H04L 67/18; G06F 3/04842; H04L 67/2842; G06F 17/30241; H04L 67/42

(57) ABSTRACT

A geospatial mapping system and method for mapping include a geospatial map server coupled to a client device, through a communication network, the geospatial map server includes a map layer selection engine that upon formation of a user account with user personal information receives a request for map tiles comprising suggested map layers, the user personal information includes a location of the client device, the server generates the suggested map layers and map tiles and deploys the generated map tiles to the client device, the deployed map tiles being a part of the generated map tiles and representing pre-defined geographic boundaries of a region (R) surrounding the location (L) of the client device. The region R is defined by boundaries of an area of a display of the client device employed by a user of the client device.

### BACKGROUND

Geospatial mapping, used to show digital representations of the globe and beyond and attributes thereof, such as earth's terrain, temperature and other associated characteristics, is prevalent. With the advent of the Internet, software has been developed to view the earth from various distances, zoom in and zoom out, among other forms of views.

Multiple approaches have led to the geospatial (digital) representation of geographic areas including terrestrial sites. One such approach includes the selection of a map layer from a client device, which may be a computer, mobile device, such as a smartphone or other computational devices with a display for viewing by a user of the device. Selection of the map layer is generally based on the area/region-of-interest to the user. Upon the selection of the map layer, “tiles” (also referred to as “map tiles”) of the selected map layer are requested of a computational device based on specified geospatial boundaries. “Tiles” are readily utilized for geospatial mapping and are used to generate a digital representation of a map for display in a browser. The request for tiles causes a query against map layers and geospatial tiles in client device cache memory and upon a match, the requested (map) tiles are deployed to the client device interface.

The generation of geospatial map layers and tiles is achieved through the processing of data. Firstly, data, potentially from multiple sources including from third party storage devices, is downloaded in its raw form, is organized into searchable database form, and stored accordingly. Map data/file is subsequently stylized by applying stylistic, visualistic, and spatial filters to the stored data, before it is converted into and stored as map layer files. Lastly, the visualized map layers are broken into tiles of congruous shapes and sizes through services including web mapping server (WMS) or a Web Mapping Tiling Service (WMTS). This process is applicable and appropriate for rendering both Raster and Vector maps and tiles.

The amount of information that can be portrayed in three dimensional map layers on a globe is vast. Currently, there is no adequate process for creating a searchable database that encompasses all available data and map layers.

### SUMMARY

Briefly, a geospatial mapping system includes a geospatial map server coupled to a client device through a communication network. The geospatial map server has a map layer sequencing engine that upon formation of a user account with user personal information, is configured to act upon a request for map tiles, from the client device. The requested map tiles are accompanied by, or include, suggested map layers that are generated by the geospatial map server. The received request includes a location of the client device. Upon receipt of suggested map layers, the client device forms a map layer catalogue that includes the suggested map layers. The suggested map layers are generated from the user personal information and available map layers in a database accessible to the geospatial map server. More specifically, a geospatial and visualization device of the geospatial map server generates the suggested map layers and map tiles. A map layer deployment engine of the geospatial map server is coupled to the map layer sequencing engine of the geospatial map server. The map layer sequencing engine deploys the generated map tiles to the client device, the deployed map tiles are merely a part of the generated map tiles and not all of the generated map tiles. They represent the pre-defined geographic boundaries of a region (R) surrounding the location (L) of the client device. The region R is defined by boundaries of an area of a display of the client device, which is employed by a user.

A further understanding of the nature and the advantages of particular embodiments disclosed herein may be realized by reference of the remaining portions of the specification and the attached drawings.

### BRIEF DESCRIPTION OF THE DRAWINGS

FIG. 1 shows a geospatial mapping system 10 of an exemplary map layer of tectonic plates is shown with many map layers saved in the database N 14 of the geospatial map server, among which is the tectonic plate map layer, shown at 16, in accordance with an embodiment and method of the invention.

FIG. 2 shows an exemplary geospatial mapping system 30 where a client device makes a request of the geospatial map server(s) 12 for map data, via a communication network, in accordance with an embodiment and method of the invention.

FIG. 3 shows another exemplary geospatial mapping system 40, in accordance with an embodiment and method of the invention.

FIG. 4 shows an exemplary geospatial map system 50, in accordance with an embodiment and method of the invention.

FIG. 5 shows a geospatial mapping system 70, in accordance with an embodiment and method of the invention.

FIG. 6 shows a flow diagram 90 of some of the relevant steps of the process for rendering unique geospatial maps relative to the geolocation of the client device using personal user data, in accordance with a method of the invention.

FIGS. 7-8 show an exemplary method of generating the searchable may layer database, such as that shown in FIG. 4.

FIG. 9 shows, in block and flow diagram form, a geospatial map system 140 and method for rendering unique geospatial maps relative to a client device geolocation using the user personal data/information (of the user profile), as described above with reference to FIG. 6.

FIG. 10 shows, in conceptual block diagram form, a geospatial mapping system 1100 including a geospatial map server 1102, communication network 1106, and client device 1104.

FIG. 11 shows a flow chart of the process 400 employed by the client device 1104 of FIG. 11 to generate indexed map layers used to display a geographic visualization of the area-of-interest to the user.

FIG. 12 shows, in conceptual block diagram form, a geospatial mapping system 500 with further details of the server 506, which is analogous to the server 1102 of FIG. 10.

FIG. 13 shows, in conceptual block diagram form, further details of the client device 1000, in accordance with a method of the invention.

FIG. 14 shows a conceptual block and timing flow of an exemplary method of the invention.

FIG. 15 shows a conceptual block and timing flow of an exemplary method of the invention.

FIG. 16 shows a flow chart of the method 3000 for providing searchable geospatial data to a client device, in accordance with a method of the invention.

FIG. 17 shows a flow chart of the method 3500 for adding new map layers and/or updating map layer tags to an indexed and searchable map layer catalogue, received from a network server, which can be deployed to the client device.

FIG. 18 shows a flow chart of the method 3400 for regenerating suggested map layers to the client device using updated user information, new map layers, or new geographic positions, which can also be implemented in the client device.

FIG. 19 shows, in conceptual form, a geospatial map system 4000, in accordance with an embodiment and method of the invention.

### DETAILED DESCRIPTION OF EMBODIMENTS

In the following description of the embodiments, reference is made to the accompanying drawings that form a part hereof, and in which is shown by way of illustration of the specific embodiments in which the invention may be practiced. It is to be understood that other embodiments may be utilized because structural changes may be made without departing from the scope of the present invention. It should be noted that the figures discussed herein are not drawn to scale and thicknesses of lines are not indicative of actual sizes.

In accordance with a method and apparatus of the invention, a geospatial mapping system generates map layers, comprised of geospatial map tiles that are deployed to the client device and employed by a user. Selection of the deployed geospatial maps and tiles is based on a matching process whereby user profile data is used to select a portion of map layers available in a database. Geospatial tiles are assembled into map layers in the client interface around a selected geographic area defined by the boundaries of the client device interface. The device, also referred to herein as “client device” may be, without any limitation, a handheld device, such as a smartphone.

In an embodiment and method of the invention, relevant map layers and data that is appropriate for users, based on the users' interests, are created for displaying on a globe relative to a user's interests and personal information.

In accordance with a method and apparatus of the invention, a user account is established by the user of the client device and upon formation of the user account with user personal information from which a map layer catalogue of suggested map layers is formed. A request is made by the client device to a geospatial map server. The geospatial map server may be made of one or more than one physical servers, which may be located in the same location or different locations.

The request is for map tiles of suggested map layers, generated by the geospatial map server. The client device and the geospatial map server communicate with each other via a communication network, such as but not limited to the Internet. The request includes the location of the client device that may be obtained through a global positioning system (GPS). The user personal information may include the location of the client device but it also includes other information associated with the user, such as gender, user preferences, and the like. The user personal information is clearly programmable by the user and may be flexibly adjusted to accommodate various users, such as those interested in a particular field, for example, geology, or those interested in population or products employed by different demographics, and many others that are too many to list here. It is therefore, a intended consequence that the various embodiments and methods of the invention will be employed in numerous varieties of applications, perhaps not even yet conceived due to the rapid advancement of technology.

The geospatial map server generates selected/recommended map layers and associated map tiles based on the selected region by the user as well as the user personal information. The selected map layers, upon transmission to the client device, form a map catalogue that may be stored in the client device for future reference. Accordingly, a client device typically accumulates many map catalogues over time.

A map layer deployment engine of the geospatial map server deploys the (selected) map layers and map tiles, through the communication network, to the client device. The deployed map tiles are a part of generated map tiles representing pre-defined geographic boundaries of a region (R) surrounding the location (L) of the client device, the region R being defined by boundaries of the selected area of the display of the client device.

In accordance with an embodiment and method of the invention, a technique that combines rastering and vector imaging is employed. Thus, use of vector imaging versus rastering is determined based on the type of data set, per various embodiments of the invention.

In accordance with an embodiment and method of the invention, map/data layers may be tiled and processed but only map tiles that are actually required are assembled in the map layer at region R. Tiles that comprise geographic areas not represented or viewed in the current device client interface are not deployed. As a user takes action, to for instance view a selected area, such as zooming in, only the image that is zoomed in is tiled with all other images remaining un-tiled. This saves processing time and power.

In an embodiment and method of the invention, a tag system is employed. In accordance with an embodiment and method of the tag system, each map layer is matched with an associated one or more other map layers through use of matched tags with a larger number of matched tags between a map layer and the one or more map layers being indicative of a stronger correlation therebetween. In accordance with an method of the invention, generating the suggested map layers occurs through a matching process performed by a map layer selection engine of the geospatial map server based on the user personal information and a map layer tagging system. The tagging process each map layer is matched with associated with one or more other map layers, through use of matched tags, and the larger number of matched tags between a map layer and the one or more map layers, is indicative of a stronger correlation therebetween. Map layers can be suggested in sequential order, in an exemplary method, such as starting with a highest match rating to a lowest match rating, wherein the map layer with the highest match rating is identified based on the user personal information, associated with the user, and the other map layers of the suggested map layers are identified based on their association with the map layer with the highest match. Close associations between the latter and the former, close being dictated by a criterion or criteria of the user's choosing, become among the suggested map layers. One such criterion is the user personal information. Accordingly, map layers are suggested, in sequential order for instance, starting with a highest match rating to a lowest match rating, wherein the map layer with the highest match rating is identified based on the user personal information associated with the user and the other map layers are identified based on their association with the suggested map layer. It is contemplated that other tagging processes may be employed without departing from the scope and spirit of the invention.

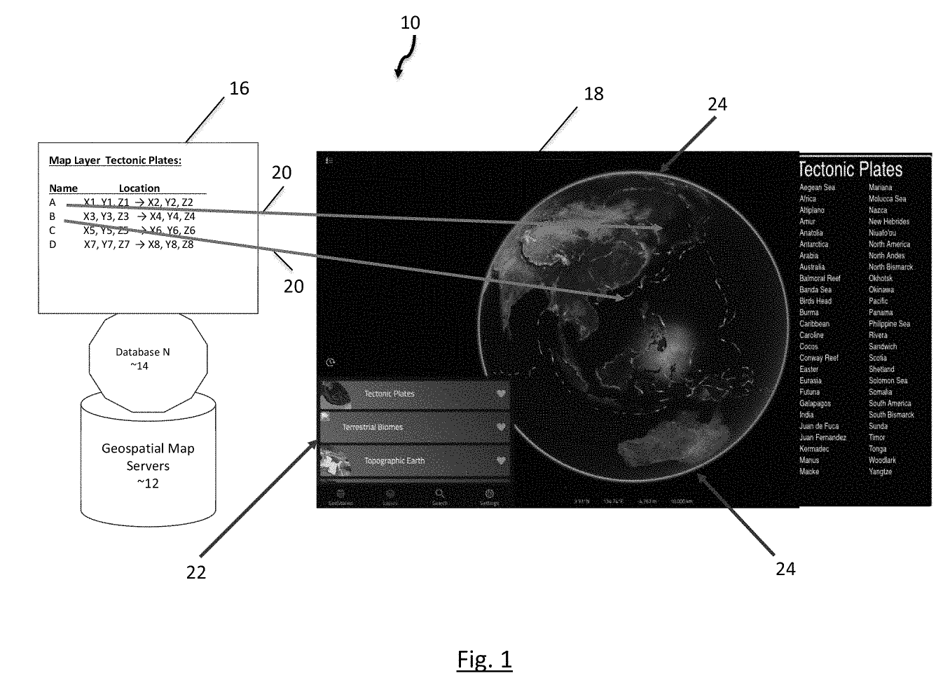

Referring now to FIG. 1, in accordance with an embodiment and method of the invention, a geospatial mapping system 10 of an exemplary map layer of tectonic plates is shown with many map layers saved in the database N 14 of the geospatial map server, among which only the tectonic plate map layer, shown at 16. The tectonic plate map layer is generated by the geospatial map server 12, which may be made of more than one server. The database N 14 may include more than one physical database and may be a part of the server 12 or located externally to the server 12, or a part of another system altogether. The map layer 16 is displayed on a three-dimensional (3D) earth viewed within the display 18, which is a part of the client device interface, as later explained relative to subsequent figures. The geospatial map server 12 is communicatively coupled to database 14. It is understood that FIG. 1 shows merely one example, among many others, of a system in which an embodiment and method of the invention may be employed.

In the system shown in FIG. 1, tectonic plates are shown graphically in the display 18 of a client device (not shown in FIG. 1) and viewed by a user thereof. The displayed tectonic plates are made of (tectonic plate) map tiles that are in turn created from (tectonic plate) map layers. Each tectonic plate map layer is used to generate tectonic plate map tiles retrieved from the database 14. Database 14 is shown to include “N” number of map layers, “N” being an integer value. Each of the N databases includes one or more map layers and associated map tiles.

Briefly, the geospatial map server 12, responds to the client device with the display 18 and generates selected tectonic plate map layers 16 and map tiles to the client device. Appropriate visualized map layer information is shown at 24 of the display 18 and discussed in further detail below.

In accordance with an embodiment and method of the invention, the contents of the database 14, as shown at 16, is a list of various locations-of-interest, associated with the selected areas, identified by a name, such as “A”, “B”, . . . , that correspond to boundaries, such as “X1, Y1, Z1-->X2, Y2, Z2” for the area identified by the name “A”. The arrows 20 are intended to show an example of the location, shown at 24, where the locations “A” and “B” are ultimately shown at 24. The map catalogue containing multiple map layers is, shown at 22 in the display 18, to the user for selection of an interested map catalogue. In this manner, previously-generated map catalogues need not be re-generated and may be instead, saved in the client device for easy access. Following the example of FIG. 1, the tectonic plate map layer is shown at 22 and saved in the client device to avoid future generations thereof. Saving a map catalogue in the client device may be selectably programmed as a part of the user personal information, in an exemplary embodiment.

The map layer/map tiling of the various embodiments of the invention may be viewed via a client device, such as but not limited to, a smartphone or mobile device and can be achieved in conjunction with the use of Application Program Interface (API) capabilities that link third party data with a geospatial map servers via cloud/web communication.

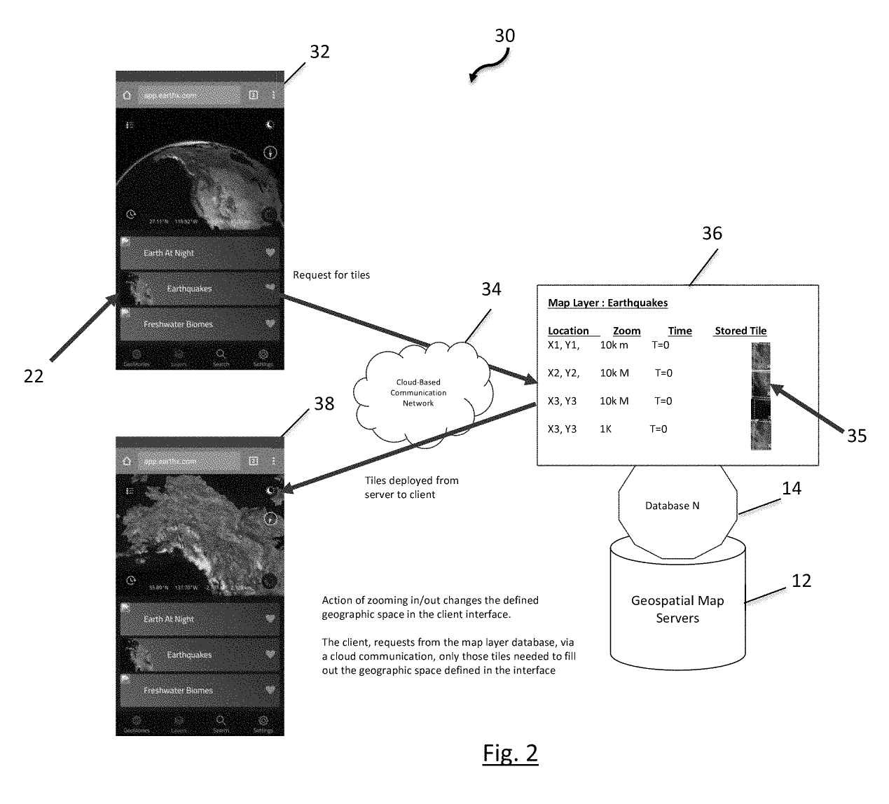

Perhaps, the greater benefit of some of the embodiments of the invention is better understood relative to FIG. 2 and its related discussion.

FIG. 2 shows an exemplary geospatial mapping system 30 where a client device makes a request of the geospatial map server(s) 12 for map data, via a communication network, in accordance with an embodiment and method of the invention. Map data would include selected map layer and map tile information. In FIG. 2, a client device whose display 32 is shown in FIG. 2, transmits a request to the server 12 and database 14, through a cloud-based communication network 34, for selected map layers and map tiles. An example of the cloud-based communication network 34 is the Internet. The particular regional attributes of interest, such as earthquakes in the case of FIG. 2, at various selected areas, along with the geolocation information of the client device 32, are also transmitted by the client device 32, through the network 34, as shown by the map layer 36, which is generally saved in the database 14. The map layer 36 is for earthquakes and is shown to show locations, a zoom area, time, and map tiles 35, with each map tile being associated with a distinct location. For example, the Location “X1,Y1”, at Zoom are 10K m, at Time 0, shows one of the map tile 35. The map tiles 35 are selected for selected map layers generated from the selected area. They are stored in the database 14 and this may or may not be selectively temporary. The generated map tiles are deployed to the client device and thereafter saved in the client device.

The database 14 and server 12 calculate selected map layers and associated relevant map tiles (associated with the selected interest from the client device) and transmit the same back to the client device 32.

Map layers of a particular selected area form a map catalogue that may be saved, or not, in the client device. Alternatively, map catalogues may be saved elsewhere including the server 12 and/or database 14.

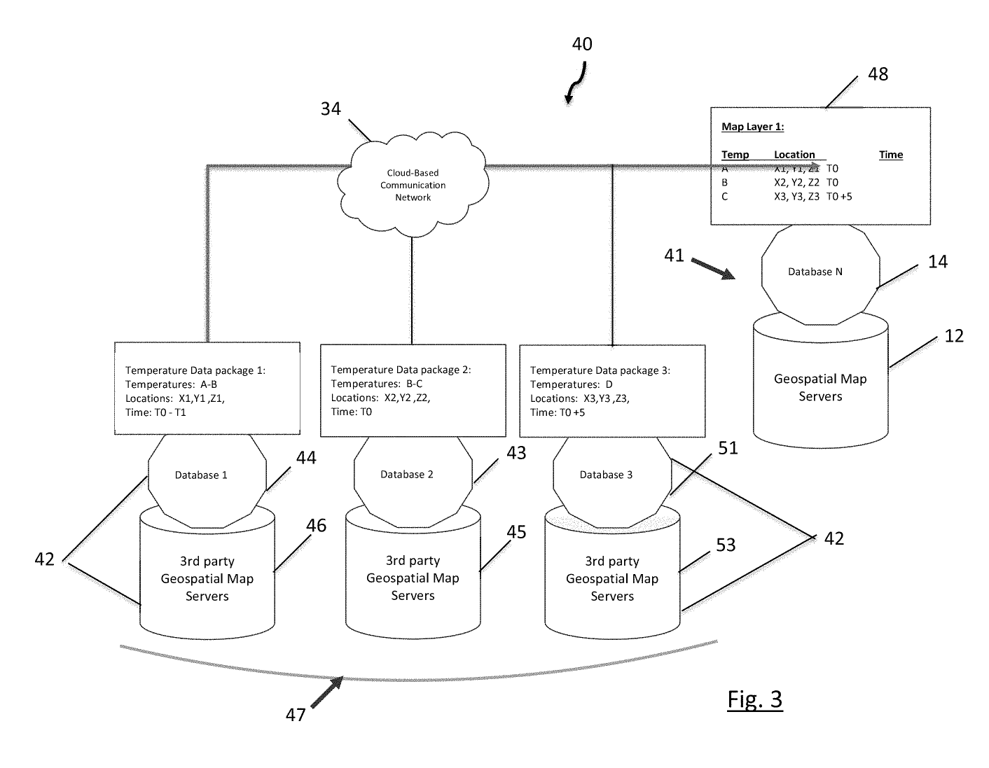

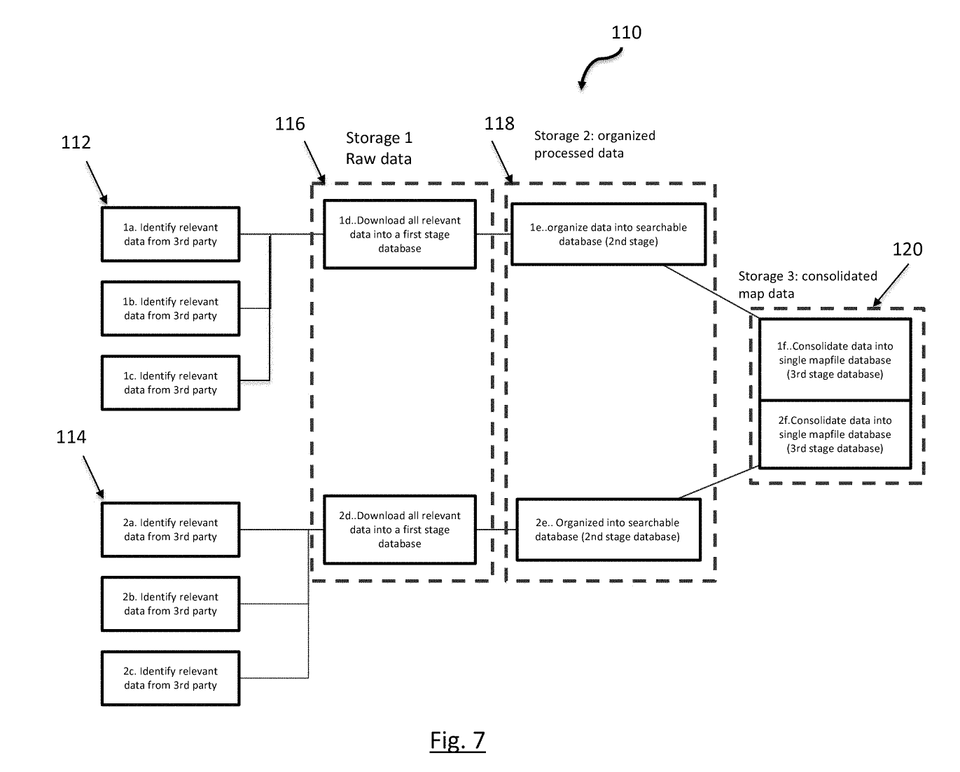

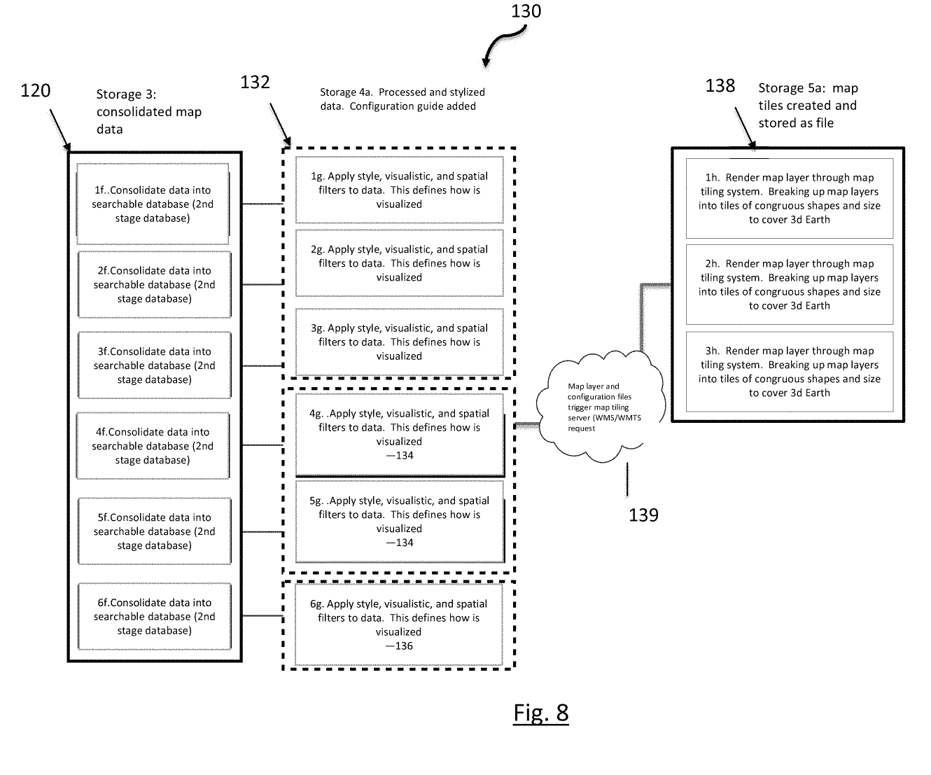

A searchable map layer database comprised of searchable map layer tiles, an example of which is shown in FIG. 3, is created in the geospatial map server 12 and database 14 pair. FIGS. 7-8 show an exemplary method of generating the searchable may layer database, as discussed below.

The area of earth shown in the display 32 of the user client device typically does not remain static and is instead oftentimes dynamic. For example, a user of the client device may choose to zoom-in and zoom-out while viewing the selected (area of) interest or may choose to view a different area-of-interest altogether. In the example of FIG. 2, a user selected one of the map catalogues of the map catalogues 22, shown at display 32 of a part of earth. This selection is communicated to the geo spatial map server 12 and database 14 through the communication network 34, in the form of a request. In the example of FIG. 2, the request is particularly for earthquake information. The geospatial map server 12 and database 14, upon receipt of this request, generates selected map layers, such as the map layer 36, for earthquakes. Generated map layers, such as the map layer 36, referred to herein as the “selected map layers”, in association with map tiles, also generated by the combination of the server 12 and database 14, are deployed to the client device through the communication network 34. The selected map layers result in the display 38 of the user's selected area where a relevant portion of the display 32 with earthquake information is shown.

In the example of FIG. 2, the user is zooming in/out of the area of earth that is shown at the display 32. Accordingly, the defined geographic space in the display 38 of the client device shows the defined geographic space (selected area) changed, such as shown at the display 38. In an exemplary scenario, the user/client makes a request of the map layer database, in this case database 14, via the cloud communication network 34, and only those map tiles that are necessary to fill out the geographic space defined in the client device, displayed at 38, are transmitted through the communication network 34, to the client device.

FIG. 3 shows another exemplary geospatial mapping system 40, in accordance with an embodiment and method of the invention. For the purpose of discussion, a server-database pair is referred to herein as the “pair 42” or “combination 42”. The system 40 is shown to include a number of third party servers and associated databases, i.e. third party geospatial map servers 46 and associated database 44, third party geospatial map servers 45 and associated database 43, and third party geospatial map servers 53 and associated database 51, with the same type or category of geospatial data For instance, the server 46 and database 44 are shown to include data with Temperature A-B, Location X1, Y1, and Z1 and Time To-T1 whereas, the server 45 and database 43 are shown to include data with Temperature B-C, Location X2, Y2, Z2, and Time T0, and so son.

Relevant data that comprise a temperature map layer is identified in multiple third party geospatial map server-database pairs 42, such as the third party geospatial map server 1 and database 1, third party geospatial map server 45 and database 2, and third party geospatial map server 53 and database 3, shown at 47. All such relevant data is transmitted, via the cloud-based communication network 34, to a single database-geospatial map server pair 41 made of the geospatial map server 12 and database 14.

While only three server-database pairs are shown at 47, in FIG. 3, it is understood that another number of pairs may be employed. The contents in each of the databases 44, 43, and 51 may or may not be of a distinct format. The contents of three databases is ultimately consolidated by the server-database pair (server 12 and database 14) shown at 41 in FIG. 3. The map layer 48, also shown as map layer 1 in FIG. 3, is made of the map layers of the databases 44, 43, and 51 and saved in a single database, i.e. database 14, shown at 41 in FIG. 3.

The data points from third parties, such as the server 46-database 44, server 45-database 43, and server 53-database 51, in FIG. 3, are transmitted through the cloud-based communication network 34, from a client device (not shown in FIG. 3) to the database 14, and compiled therein. The data points from the third party server-database pairs 42 are saved in the database 14, at 41, and together comprise the necessary data to create a map layer, such as the map layer 48. The single map layer database 14, shown at 47, is ultimately created by uploading various data and groups of data from the different databases 44, 43, and 51, shown at 47, of the client device 42. Stated differently, the uploaded data and groups of data are subsequently compiled into a single database, such as the database 14, shown at 41, and sorted. These data comprise all of the data needed to compose a single map layer, i.e. map layer 48.

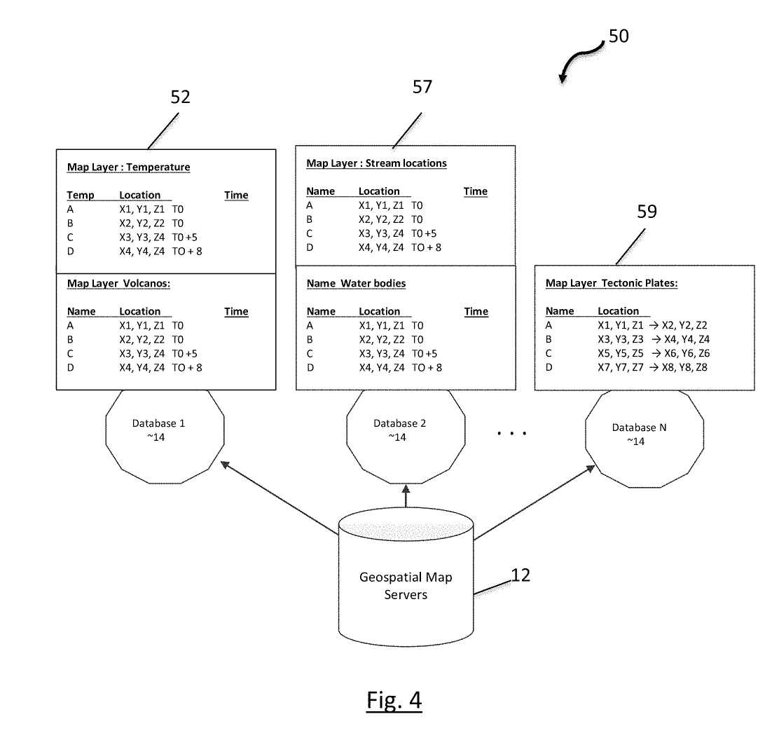

FIG. 4 shows an exemplary geospatial map system 50, in accordance with an embodiment and method of the invention. The system 50 is shown to each one or more map layers, for example, map layers 52, map layers 57, and map layer 59, all of which are stored in one or more databases 14. The map layers 52 includes two map layers, one for temperature and another for volcanos, map layers 57 similarly includes two map layers, one for stream locations and another for water bodies, and map layer 59 includes one map layer that is for tectonic plates. Alternatively, the map layers may includes any number of map layers and are not limited to two.

The databases of FIG. 4 can be thought of as folders in that any number of map layers may be included in a single database (or folder). Alternatively, multiple folders may be stored in the server 12. By way of example, N number of databases 14 (“N” being an integer value) are shown included in or in association with the server 12.

Each of these databases stores one or more map layers. For example, one of the databases 14 stores map layers for temperature and volcano, another stores map layers for steam locations and water bodies and a third database stores one map layer for tectonic plates.

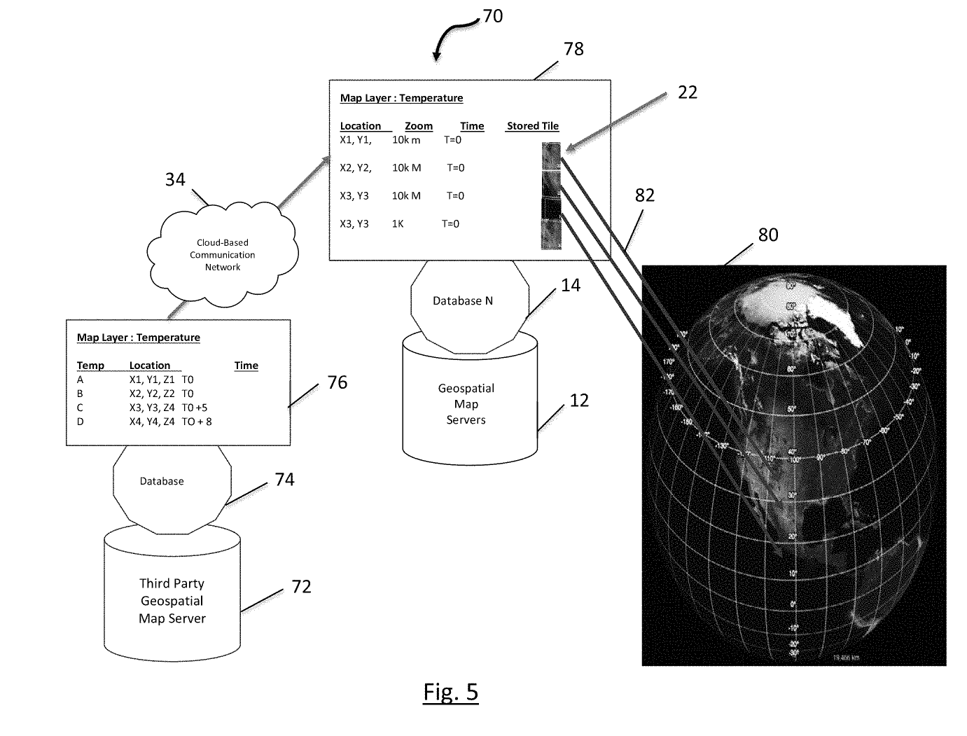

FIG. 5 shows a geospatial mapping system 70, in accordance with an embodiment and method of the invention. In FIG. 5, the system 70 is shown relative to the process of deploying map tiles that are stored in the database 12. That is, the temperature map layer 76, from the third party geospatial map server 72 and database 74, is transmitted through the cloud-based communication network 34, to the pair server 12-database 14, which are shown to include the map layer 78. The map layer 78 is shown to include the map tiles 22, which are generated by the server 12, and stored in the database 14. Three of the stored map tiles 22 are shown mapped to points of the globe representing the geographical location mapped by the map layer 78 of the display 80 of a user's client device (not shown in FIG. 5).

In the example of FIG. 5, the map layer 76 is a temperature map layer, made of data and groups of tables that are generated by the third party geospatial map server 72 and associated database 74. The map layer 76 is comprised of geospatial tiles and associated data or data set.

In map layer 76, a data group named “A”, is located at “X1, Y1, Z1”, at Time T0 and the data group named “B”, is located at “X2, Y2, Z2”, at Time T0, and data group named “C” is located at “X3, Y3, Z4” at Time T0+5, and so on. This map layer data is transmitted through the network 34 to the database 14 where, in combination with the server 12, map tiles are rendered. The tiles define various points of the globe in the display 80. For example, the first map layer at location “X1, Y1” and Zoom level 10 kilometers, at time 0 (T0), translates into the tile shown at 82 and so on. These tiles are shown with greater resolution in the display 80 as opposed to tiles that are located farther away from the zoomed view that is identified by the map layer 78.

At 78, the temperature map layer generated by the server 12-database 14 includes map tiles 22, which are derived from the received map layer 76. The top-most tile, points to Location: X1, Y1 and zoomed to 10 Kilometers, at Time T=0, and the second top-most tile points to Location: X2, Y2, and zoomed to 10 Kilometer, at time T=0, and so on.

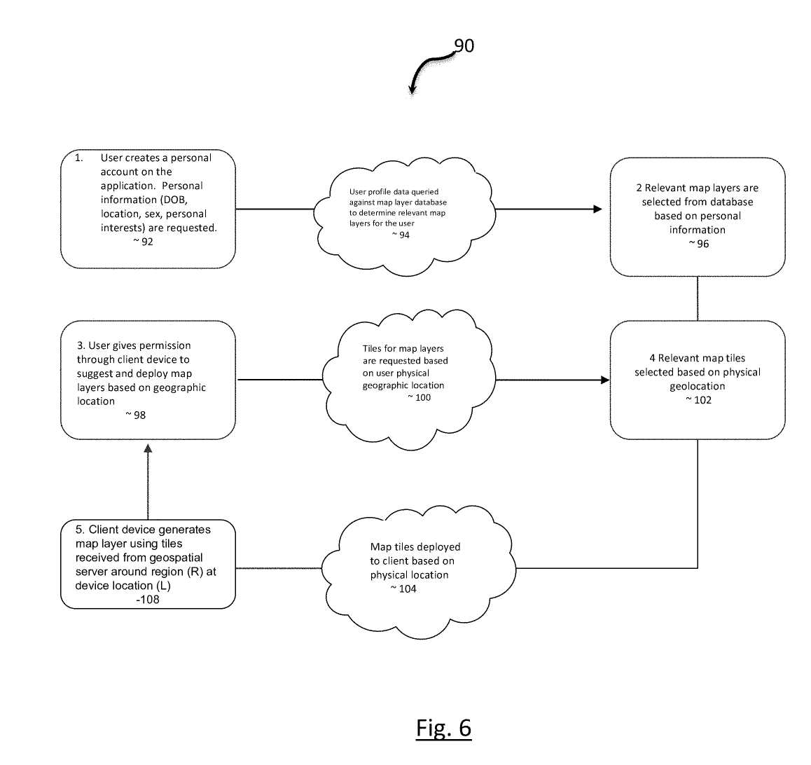

FIG. 6 shows a flow diagram 90 of some of the relevant steps of the process for rendering unique geospatial maps relative to the geolocation of the client device, using user personal information, in accordance with a method of the invention. At 92, a user of the geospatial map system of the various embodiments of the invention creates a personal account. Additional information may be gathered through a user interface (UI). Further, additional map layers may be suggested based on additional map layers made available through the API and/or the additional user information made available through the API. The user enters its personal information, such as date of birth, location, gender and personal interests, as requested upon execution of the application. User information is typically supplied through the user's mobile or non-mobile device but may be located externally to the user's device and in communication therewith. The information entered by the user defines the user profile or user profile data and is selectively programmable by the user in that other types or different user information. The location of the user becomes the location of the user's device, or client device.

Next, at 94, the user profile, created at 92, is queried against a map layer database in the network server to determine the relevant map layers for the user. The map layer database, comprised of many thousands of map layers, is created and stored in the geospatial map server, such as the server 12 of previous figures.

Next, at 96, the relevant map layers of 94 are selected from a database (such as the database 14), which is generally database(s) that are associated with the geospatial map server, based on the user profile data (or information). Next, at 102, relevant map tiles that are selected based on the physical geolocation of the client device are generated. Subsequently, the selected or relevant map tiles around region (R) at the client device location (L) are deployed to the client device through the communication network based on the physical location of client device or region of interest shown on the display of a client device interface. Thereafter, at 108, the client device generates one or more map layers using the map tiles deployed at 104.

At 98, the user gives permission, through client device, to suggest and deploy map layers that are based on the geographic location of the client device which have been pre-selected by the geospatial map server 12. This pre-selection is based on the physical geographic location of the client device. Then, at 100, the client device makes a request, of the geospatial map server 12, for map tiles of map layers based on the user's physical geographic location (suggested at 98). These map layers have been pre-selected at 96, as explained above.

At 102, the geospatial map server, in combination with the associated database, selects relevant map tiles associated with the pre-selected and relevant map layers. This selection is made based on the physical geolocation of the client device. Finally, the relevant map tiles are deployed to the client device based on the physical location of the client device, as stored in the database associated with the geospatial map server, at 104.

FIGS. 7-8 show an exemplary method of generating the searchable map layer database, such as the database 14 shown in FIG. 4, in accordance with a method of the invention. It is understood that methods other than those described relative to FIGS. 7-8 relating to the organization and storage of data used to generate map layers may be employed.

Referring now to FIG. 7, the process of creating a searchable map layer database, corresponding to the embodiments of FIGS. 3-4, is described. Two sets of identified relevant data from third parties, i.e. sets 112 and 114, are shown, each providing raw geospatial data to storage 1 116. These two sets of data are examples where often times multiple sets of data, which in the example of FIG. 7 is two sets, are required to generate a map layer. It is understood that other number of sets of data may be employed and that two sets is shown in FIG. 8 merely for the purpose of illustration.

An example of a map layer with multiple sets of data is a temperature map layer, which may require 13 sets or more of data. All of the data of a single data set is stored into a single database, such as storage 1 116, in the form of raw geospatial data. It may be subsequently combined and reordered into another database 118 for purposes of improved indexing and search functionality, i.e. data that is organized into searchable database data. The three data groups in the data set 112 are consolidated into one raw data group and stored in the storage 116. Similarly, the three data groups in the data set 114 are consolidated into one raw data group and stored in the storage 116.

The stages shown in FIG. 7 are analogous to a document management system in that data from 112 and 114 is downloaded and saved at 116 (into Storage 1). At 118, the saved data of 116 is revised and organized, or not, and saved (into Storage 2). The revised data may or may not be again revised, organized, and saved into another data storage unit and consolidated at 120 (Storage 3).

Next, the searchable data, which is provided to the storage 3 120, is consolidated into a single map file and the single map file is stored in the storage 3 120. It is noted that for each set of data 112 and 114, a distinct raw geospatial data is created and stored in storage 1 116 and organized into searchable data and stored in storage 2 118 and the searchable data is ultimately consolidated and stored in storage 3 120.

After stage 3, as shown in FIG. 8, the single map file, which is stored in storage 3 120, is made searchable resulting in the storage 3 120 maintaining groups of consolidated and searchable data for the various map layers created from the relevant data from third parties. The consolidated searched data is transmitted from the storage 3 120 to the storage 4 132 where style, visualistic, and spatial filters are applied to the data. The user's preferences from the user profile may be utilized to help with the style and visualistics. This defines how the region-of-interest in the map is ultimately visualized. Next, at 139, the map layer and configuration files trigger map tiling by the geospatial map server through a known process referred to as Web Mapping Service/Web Mapping Tiling Service. The databases at 132-136, in FIG. 8, are analogous to the databases 52-59 of FIG. 4.

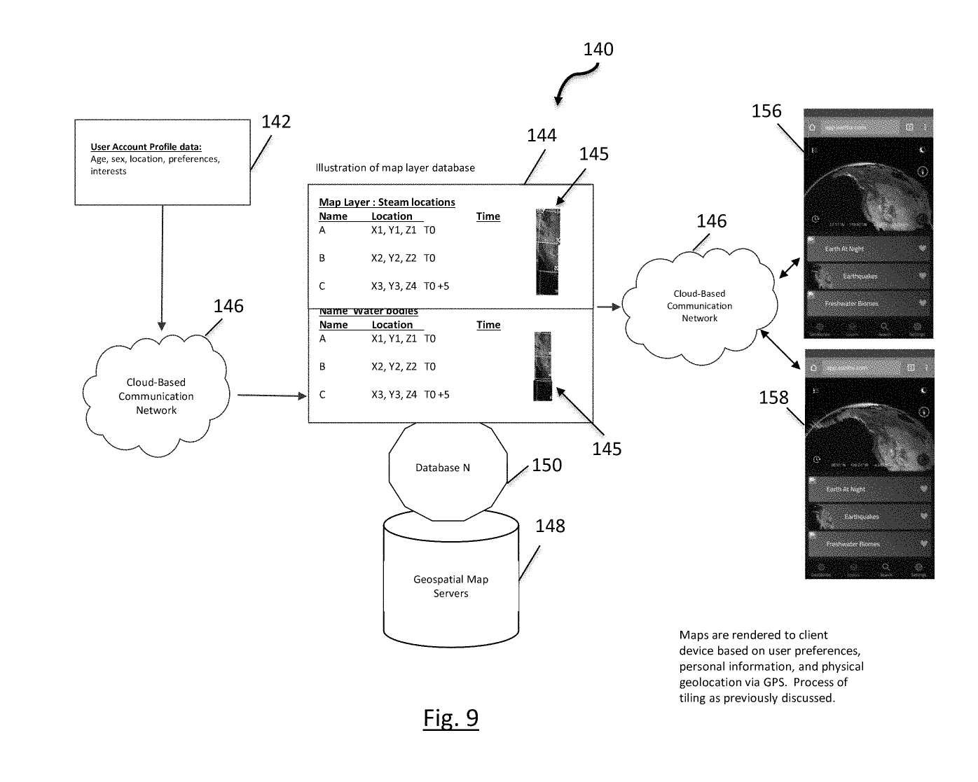

FIG. 9 shows, in block and flow diagram form, a geospatial map system 140 and method for rendering unique geospatial maps relative to a client device geolocation using the user personal data/information (of the user profile), as described above with reference to FIG. 6. In FIG. 9, at 142, a user account is established, as a part of the user profile, with the user personal information, such as age, gender, location, preference, interests, and the like. The established user profile is transmitted, by the client device, through the cloud-based communication network 146, such as the Internet, to the geospatial map server 148 and database 150.

The database 150 is a map layer database that stores various map layers, such as those shown in FIG. 9, the Stream Locations Map Layer(s) and Water Bodies Map Layer(s). The Stream Locations Map Layer, which would include the locations of stream around the globe have associated data or data groups identified by the names “A”, “B”, “C”, and “D”. Each map layer 144 is analogous to the map layers described earlier, with each map layer 144 being comprised of searchable indexed geospatial tiles 145 with locations and searchable names associated with geographic positions (for example, the top-most tile is identified by the Name A, and Location X1, Y1, Z1, and time T=0) and the second top-most tile being identified by the Name B, Location X2, Y2, Z2, and Time T0 and so on. Each of the map layers in database 150 is comprised of independent associated geospatial map tiles.

The map layers of the map layer database 144 are rendered to the display 156 and 158 of a client device, through the network 146. In an exemplary embodiment, the display 156 may show a view that is zoomed out and the display 158 is a view that may be zoomed in. Based on the user preference, personal information, and physical geolocation, all of which are a part of a user profile, defined at 142, are used to render the map tiles that ultimately form the displays 156 and 158. The physical geolocation of the client device, in an exemplary embodiment and method, is determined with the use of global positioning satellite (GPS). The process of map tiling the map layers, as previously discussed, is performed by the geospatial map server 148 and associated database 150, which are analogous to the geospatial map server 12 and database 14 of prior figures.

Accordingly, in an embodiment and method of the invention, a client device makes a request to a geospatial map server, via a communication network, such as but not limited to the Internet. The request may be an express request, in the form of, for instance a command, or it may be implied, by for example, the establishment of a user profile by the user. Either one of the foregoing triggers the process of rendering map tiles. Map data are organized into (map) tiles and have predetermined geometries of congruent shapes. Alternatively, map tiles may have non-linear geometries relative to each other.

Using the geographic of the user of the client device, typically determined through GPS, the client device requests of the geospatial map server to map tiles and render digital maps of the immediate geographic area (i.e., the user's location) according to predefined spatial boundaries. The client device request for geospatial data includes the location and description for each map tile. Requested tiles are deployed from the geospatial map server to the client device, via the communication network.

Multiple map layers, comprised of temporal and spatial scaled data, are stored in a central database in the client device. The selection and presentation of the map layers displayed to the user on a display, such as the displays 156 and 158, is determined through a unique matching process using personal information supplied by the user (see FIG. 6). Personal information is input through the client device, such as but not limited to, through an application interface in the client device, and transferred to the geospatial map server via the communication network. It is understood that the communication network uses a known protocol for causing communication between the client device and the geospatial map server.

Personal Information is stored in searchable dynamic libraries in the client server. Such information includes, without limitation, the user's location, age, gender, personal preferences, and a list of favorite subject matters (e.g. biology, chemistry, plants, technology, humanity), among perhaps other preferences and/or a subset of the foregoing preferences except that the user's location is not optional. As expected, the greater the user's preferences are known to the system, the better the outcome of the display to the user.

Personal information stored in the central database or a database of the client device and transmitted to the geospatial map server and associated database is matched against the contents of a map layer database, stored in the database, associated with the geospatial map server, using a custom process and via a network communication protocol. Relevant matched map layers are pre-selected and transmitted to the client device for visualization by the user through the client device. Through the tiling process previously described, the selected map layers are tiled into the pre-defined geographic boundaries in the client device's client interface via a communication network.

Among many usages of the embodiments and methods of the invention, the following is a short list of them:
1. Time-series maps can be used to show all of the temporal and spatial data changes occurring after the birth date of the user, i.e. personal information such as birthdate can be used to assemble the maps which have a time series beginning with your birthday (i.e. showing global temperatures changes starting from your birthdate);
2. Location-based maps may be used to show all of the relevant spatial and temporal information, such as watersheds occurring within a 5 mile radius of a user's home address;
3. Assuming a user's preferences include the jaguar being a preferred animal, map layers are shown to the user, at the client device, that visualize the global geographic distribution of jaguar populations and their native habitat;
4. Personal information such as gender can be used to find all of the same gender in a specific area of interest (ex. by country or global);
.
.
.
and so on.

These are among the numerous applications, too many to list, of the various information that may be used, in a graphical visual, to a user of the various embodiments and methods of the invention.

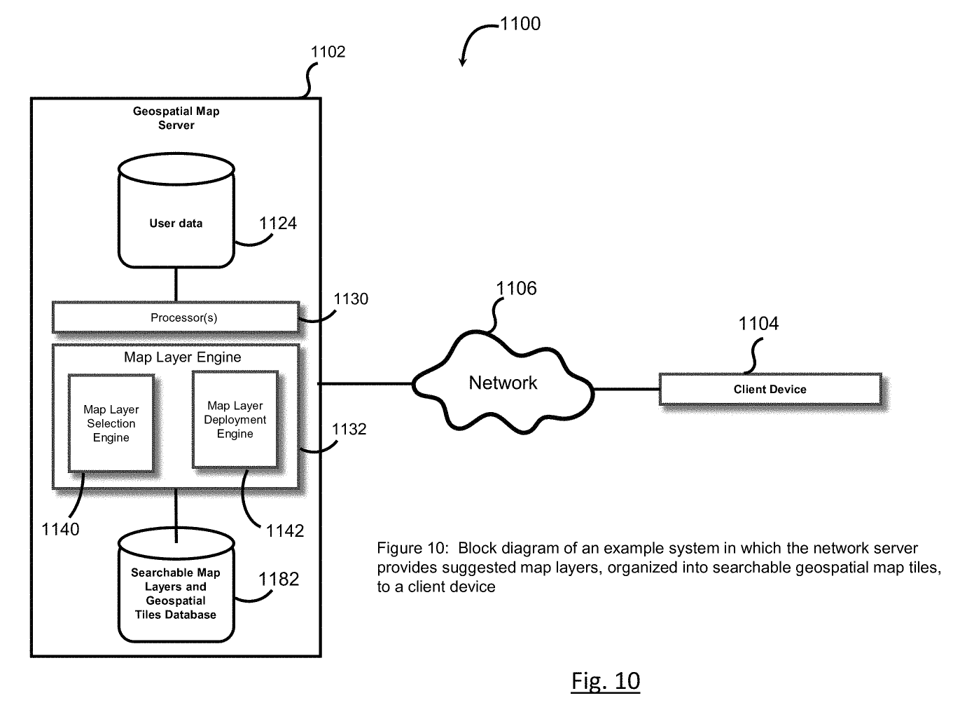

FIG. 10 shows, in conceptual block diagram form, a geospatial mapping system 1100 including a geospatial map server 1102, communication network 1106, and client device 1104. The geospatial map server 1102 is shown to include a user data storage 1124, one or more processors 1130, a map layer engine 1132, and a searchable map layers and geospatial tiles database 1182, in accordance with an embodiment of the invention. The map layer engine 1132 is shown to include a map layer selection engine 1140 and a map layer deployment engine 1132 communicatively couple to one another.

The user data storage unit 1124 maintains user data as described above. The processors 1130 transmit the user data from the user data storage unit 1124 to the map layer engine 1132 and specifically to the map layer selection engine 1140. The map layer selection engine 1140 further receives the database of all map layers, which along with the user data, is provided by the client device 1104 through the communication network 1106. The map layer selection engine 1140 is also configured to detect updated user data/information from the client device 1104 through the communication network 1106. Accordingly, upon the user taking an action that affects the digital representation of the geospatial graphics, such as zooming in or zooming out, the engine 1140 is capable of detecting the same because the user information/data in the storage unit 1124 changes.

The database 1182 maintains a searchable version of map layers and geospatial tiles. The selection engine 1140 performs a search of the database 1182 for the relevant map layers. Upon detecting a match, the selection engine 1140 realizes recommended/suggested map layers from the database 1182 and is able to provide the same and associated geospatial tiles to the deployment engine 1142. Accordingly, the selection engine 1140 generates suggested/recommended map layers, organized into searchable (geospatial) map tiles. These searchable map tiles are transmitted to the deployment engine 1132.

The deployment engine 1132 deploys the searchable (geospatial) map tiles to the client device 1104 through the network 1106. The deployment engine 1132 also communicates with the client device 1104, via a communication network 1106, and responds to updates made by the client device, (i.e. the geolocation changes) to ensure that pre-selected map layer are continuously deployed around the client device's' geographic position, location L.

The processors 1130 are used by the selection engine 1140 and deployment engine 1132 for calculation or processing of the above-discussed steps. The network 1106 is analogous to the network 34 of prior figures, such as FIG. 6, the server 1102 is analogous to the server 12 of FIG. 5, the database 1182 is analogous to the databases 52 of FIG. 4, and the client device 1104 is analogous to the client devices showing the displays 156 and 158 in FIG. 9.

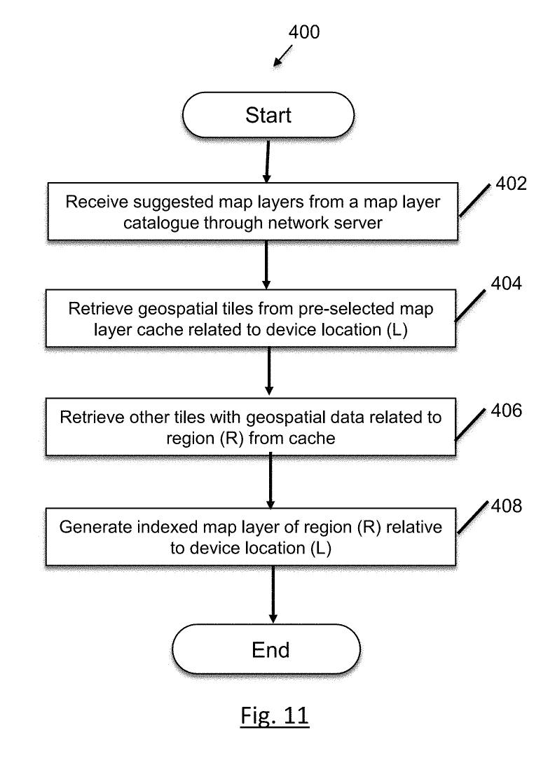

FIG. 11 shows a flow chart of the process 400 employed by the client device 1104 of FIG. 10 to generate indexed map layers used to display a geographic visualization of the area-of-interest to the user. At step 402, the client device 1104 receives suggested map layers, as described above, from the server 1102. This is performed through the network 1106. The suggested map layers are a part of the map layer catalogue.

Next at 404, the client device retrieves geospatial (map) tiles that are pre-selected map layers, maintained in cache memory of the client device and originating from the from the server 1102. The geospatial (map) tiles are related to or define the actual location of the client device, which shall be referred to herein as location (L).

At 406, the client device also retrieves other geospatial (map) tiles with geospatial data related to, or defining, the region (R) from its cache memory. “R” represents the region defined by the region-of-interest to the user. Next, at 408, the client device generates indexed map layers of the region R relative to the client device location L and the process ends. The generated indexed map layers are saved in the client device cache memory.

By way of example, as a method to manage client device memory storage, when a user's memory becomes full as a result of storing multiple map layers and the associated data, map layers which have not been recently viewed are automatically taken out of stored cache memory so as to provide additional memory availability to store additional map layers.

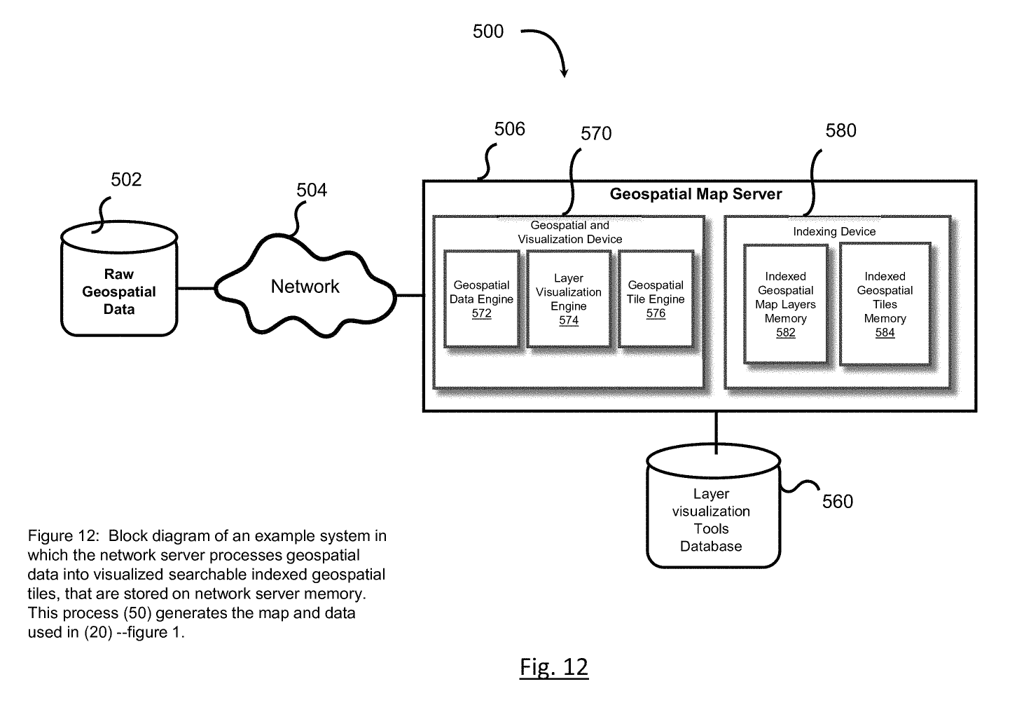

FIG. 12 shows, in conceptual block diagram form, a geospatial mapping system 500 with further details of the server 506, which is analogous to the server 1102 of FIG. 10. The server 506 receives raw geospatial data 502 from the client device, as previously discussed relative to prior figures. The server 506 is shown to include a geospatial and visualization device 570 and an indexing device 580. The layer visualization tools database 560 is in communication with the network server 506.

The geospatial and visualization device 570 is shown to include geospatial data engine 572, layer visualization engine 574, and geospatial tile engine 576. The indexing device 580 is shown to include indexed geospatial map layers memory 582 and indexed geospatial tiles memory 584. It goes without saying that the indexed geospatial map layers memory 582 maintains indexed geospatial map layers and the indexed geospatial tiles memory 584 maintains the indexed geospatial tiles.

The system 500 generally processes the raw geospatial data 502 into indexed visualized map layers that are further subdivided into indexed searchable tiles. As previously explained, the raw geospatial data 502 is received through the network 504. The geospatial data engine 572 processes and organizes the raw geospatial data 502 into searchable geospatial data. For example, as noted with reference to prior figures, the raw geospatial data is organized into groups of data according to their corresponding map layers. For instance, the data relating to the map layer for temperature are grouped together.

Processing and organizing of the raw geospatial data 502 is shown and described relative to FIGS. 7-8 hereinabove. In summary, multiple datasets are downloaded and consolidated into a single database, and then manually sorted, copied, pasted, revised, . . . , into another database, etc. . . . . FIGS. 7 and 8 show an exemplary method of progressively grouping and sorting datasets.

Once processed and organized, the geospatial data, in FIG. 12, is provided to the layer visualization engine 574 to be stylized for artistic effect using the tools available in the layer visualization tools database 560. Application of the tools of database 560 to the data, by the layer visualization engine 574, generates a map layer. Lastly, the generated map layer is processed into indexed individual geospatial tiles (“indexed map tiles”, “indexed geospatial tiles”, or “geospatial (map) tiles”) using the geospatial tile processor 576. The indexed visualized map layers 582 and their associated tiles 584 are stored in the indexed geospatial map layers memory 582 and the indexed geospatial tiles memory 584, respectively, of the index device 580 within the network server 506. The indexed geospatial map layers in the memory 582 and the indexed geospatial tiles in the memory 584 are ultimately deployed to the client device.

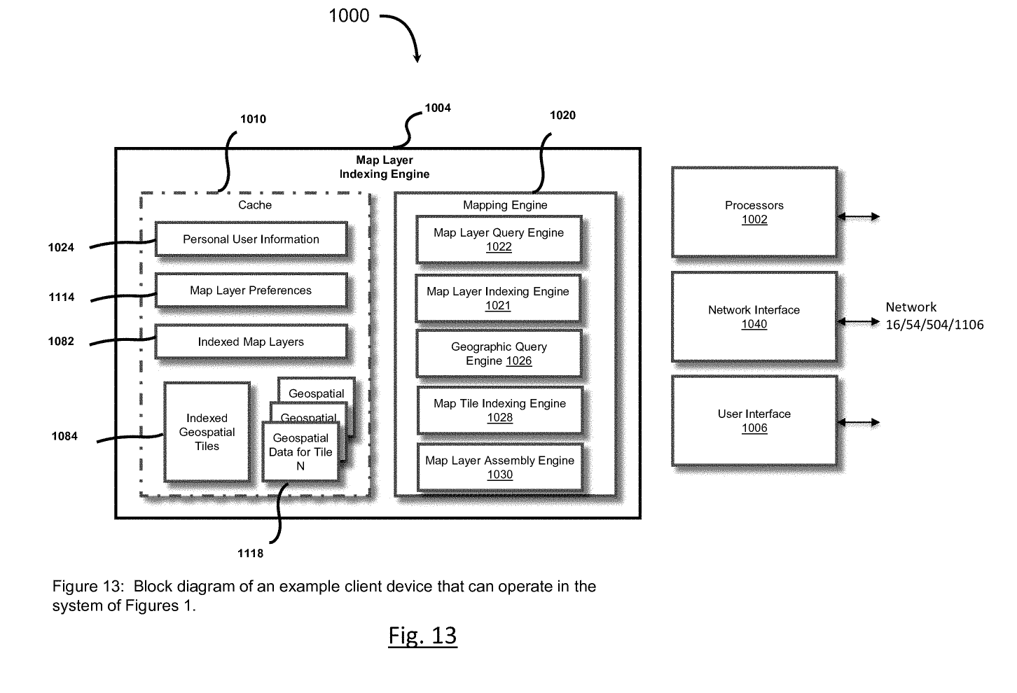

FIG. 13 shows, in conceptual block diagram form, further details of the client device 1000, in accordance with a method of the invention. The client device 1000 is analogous to client devices previously shown and discussed, such as client device 1104. The client device 1000 is shown to include a map layer indexing engine 1004, processors 1002, network interface 1040, and user interface 1006. The map layer indexing engine 1004 is shown to include cache 1010 and mapping engine 1020. Cache 1010 is made of cache memory generally known to those in the art and is shown to maintain various information. Personal user information 1024, map layer preferences 1114, indexed map layers 1082, indexed geospatial tiles unit 1084, and “N” number of geospatial data for tiles 1118, “N” being an integer value, are representative information that are saved in the cache 1010. Cache 1010, as shown in FIG. 13, is partitioned as shown in FIG. 13 and discussed herein below. Briefly, these partitions include the personal user information 1024, the map layer preferences 1114, the indexed map layers 1082, the indexed geospatial tiles 1084 and the geospatial data for tiles N 1118.

The personal user information 1024 and the map layer preferences 1114 are a part of the user profile, discussed earlier. The personal user information 1024 may include the gender and various other information about the user and the map layer preferences 1114 may include preferences of the user, such as favorite subject matter (chemistry, biology, technology, water environments), social functions (music, popular locations, sounds), and the like. The mapping engine 1020 is shown to include a map layer query engine 1022, a map layer indexing engine 1021, a geographic query engine 1026, a map tile indexing engine 1028, and a map layer assembly engine.

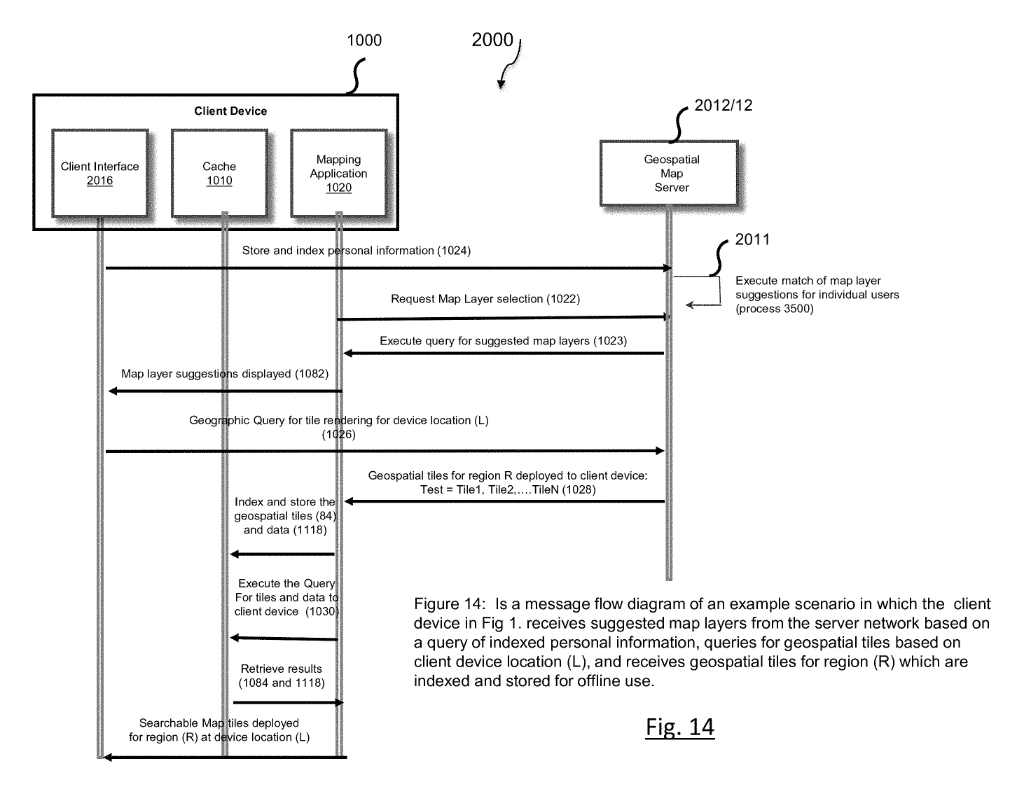

The indexed map layers 1082 are assembled by the client device, namely, into a map layer catalogue. Indexing is performed by the map layer indexing engine 1021 and stored in the indexed map layers 1082 of the cache 1010 (also shown and discussed relative to FIG. 14). Indexing the catalogue may be updated by the user. Examples of indexing the catalogue may be using alphabetical ordering, newest-to-oldest ordering, most popular-to-least popular ordering, among others.

Indexed geospatial tiles 1084 are generated through the process previously described relative to FIGS. 7 and 8, namely at 138-139. A request is made by the map tile indexing engine 1028 to the geospatial map server. The (map) tiles are sent back and stored in cache memory, cache 1010, and subsequently assembled by the map layer assembly engine 1030.

The geospatial data for tile 1118 are the raw geographic data 502, in FIG. 12, which is used in the process at 500 to generate stored and indexed geospatial tiles 1084. The raw geospatial data (also referred to herein as “geospatial data for tile N”) 1118 may or may not be saved in coordination with the indexed geospatial tiles 1084, in the cache memory 1010, of the client device.

The map layer query engine 1022 makes the requests of the geospatial map server, through the communication network, for suggested/recommended map layers 1082.

The map layer indexing engine 1021 builds the map layer catalogue, such as the catalogue 144, from the map layers. The geographic query engine 1026 communicatively couples to the geospatial map server, such as server 12, to determine the geographic position of the client device. The map tile indexing engine 1028 organizes and indexes the tiles and stores them in cache memory and the map layer assembly engine 1030 functions to render the indexed geospatial tiles around region R at the location L of the client device, as previously described.

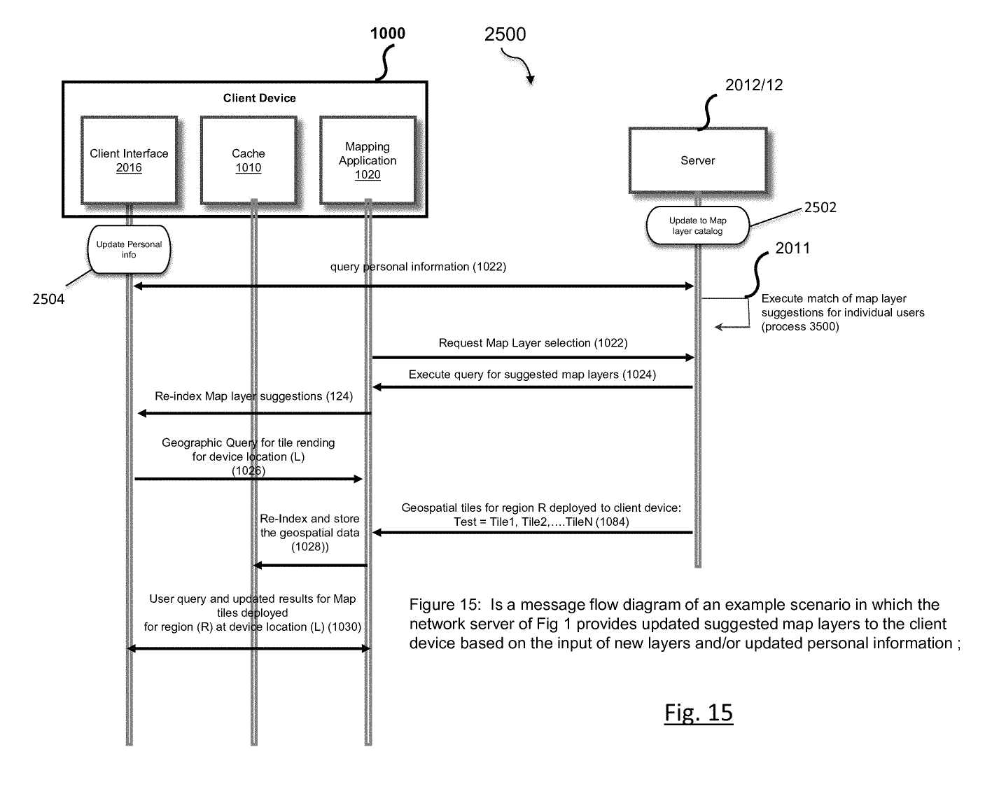

The personal user information 1024 is used to query the geospatial map server, as discussed in FIGS. 14 and 15 (2000 and 2500), and the resulting matched suggested map layers, or map layer preferences 1114, in FIG. 13, are transmitted to, indexed, and stored in the local client device, specifically in the indexed map layers 1082 portion of the cache 1010. These suggested map layers are catalogued by not only map layers geospatial tiles, they are also the data that forms the contents in the geospatial data for tiles 1118.

The processors 1002 are employed by the map layer indexing engine 1004 for various computations, the network interface 1040 serves to interface between the remainder of the client device and the communication network for communicating with the geospatial map server. The user interface 1006 causes the user and the client device to communicate with each other. The network interface 1040 and the user interface 1006 may have any interface that is compatible with the client device and the communication network and the user, respectively.

In an embodiment of the invention, the mapping engine 1020 is an application that may reside in a smartphone or other mobile device or even a computer. Alternatively, the mapping engine 1020 is made of hardware or a combination of hardware and software.

FIG. 14 shows a conceptual block and timing flow of an exemplary method of the invention. In the process 2000 of FIG. 14, in summary, the client device receives suggested map layers from the geospatial map server 2012 (analogous to server 12), based on a query of indexed personal information, and receives queries for geospatial tiles, based on client device location (L), and receives geospatial tiles for region (R) which are indexed and stored for offline use. Various tasks performed by the client device and server reference blocks in FIG. 15.

More specifically, as shown in and discussed relative to FIG. 15, the client interface 2016 (also referred to herein as “client device interface”) of the client device 1000, which is a combination of the network interface 1040 and the user interface 10006 and includes the display discussed herein, is shown to send the user personal information 1024 to the geospatial map server 2012 for storage therein. At 2011, the server 2012 executes a matching function to find a match of the map layer suggestions for the user, further discussed below, relative to subsequent figures.

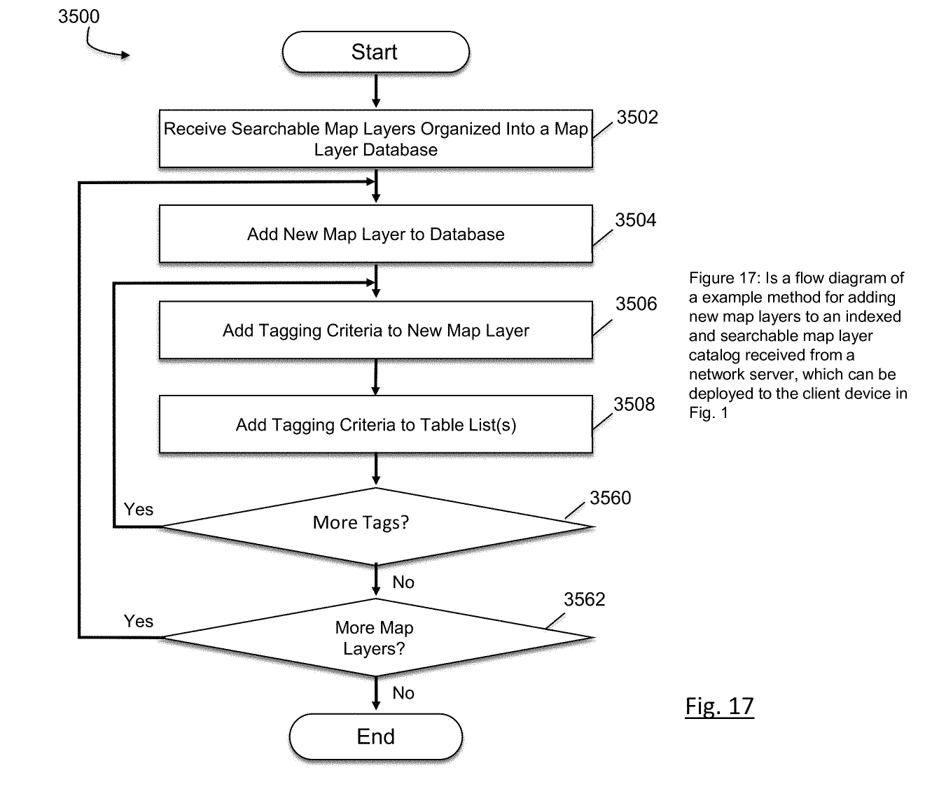

Additionally, the mapping application 1020 sends a request to the map layer selection engine 1140 of the server 2012 (shown in FIG. 10) thereby triggering the matching process (such as shown by the process 3500 of FIG. 17), performed by the server 2012, and more specifically by the map layer selection engine 1140 (shown in FIG. 10) of the server 2012.

Upon the server 2012 executing a match, at 2011, a database (such as in the database 14) of suggested map layer(s) relative to the user personal information is created. The mapping application 1020 then makes a request for the suggested map layers, from the geospatial map server 2012, and in return, the geospatial map server 2012 executes a query and sends (or deploys) the suggested map layers to the client device mapping application 1020. Thereafter, the mapping application 1020 of the client device 1000 sends the suggested map layers, received from the server 2012, to the client interface 2016 of the client device 1000 for displaying to the user 1082. Accordingly, the suggested map layers are displayed to the user by the client interface 2016.

Next, through the client interface 2016, a query is generated from the geographic query engine 1026 of the client device 1000 to the server 2012 for geographic map tile(s) for rendering for the client device, at the location L of the client device. Location L may be determined using a GPS, among perhaps other methods. In return, the server 2012 deploys the geospatial (map) tiles, for region R, to the mapping application 1020 of the client device 1000. For example, for the Tile1, Tile2, . . . , TileN for map layer “Tectonic Plates” are deployed to the map tile indexing engine 1028, residing in the mapping application 1020 of the client device 1000, which is analogous to the mapping engine 1020 of FIG. 13.

Subsequently, the mapping application 1020 indexes the geospatial (map) tiles 1084, and stores them, along with the tiles 1118 in the client device cache memory 1010. The indexed geospatial map tiles are subsequently made available in the map layer catalogue that is visible to the user, through the client interface 2016.

Next, the map layer assembly engine 1030, of the mapping application 1020, executes a query to the cache 1010 for tiles and data and as a result, retrieves the tiles and data from the indexed geospatial tiles 1084 and the geospatial data for the tiles 1118 of the cache 1010. When a user introduces a change to its view/imagery, i.e. the region R changes, an interaction with the client interface 2016 (of the client device) and recognition by the mapping engine 1020 (of the client device) to build the map layer of region R, as defined by the geographical boundaries shown in the client device, takes place. Updates occur in the selection of the suggested map layers that make up the map layer catalogue, which is unique to an individual (user) based on their personal information. Alternatively, updates occur in the process of deploying map layers relative to their geographic location. Updates to the user information results in updating of the map layer catalogue and associated geospatial tiles.

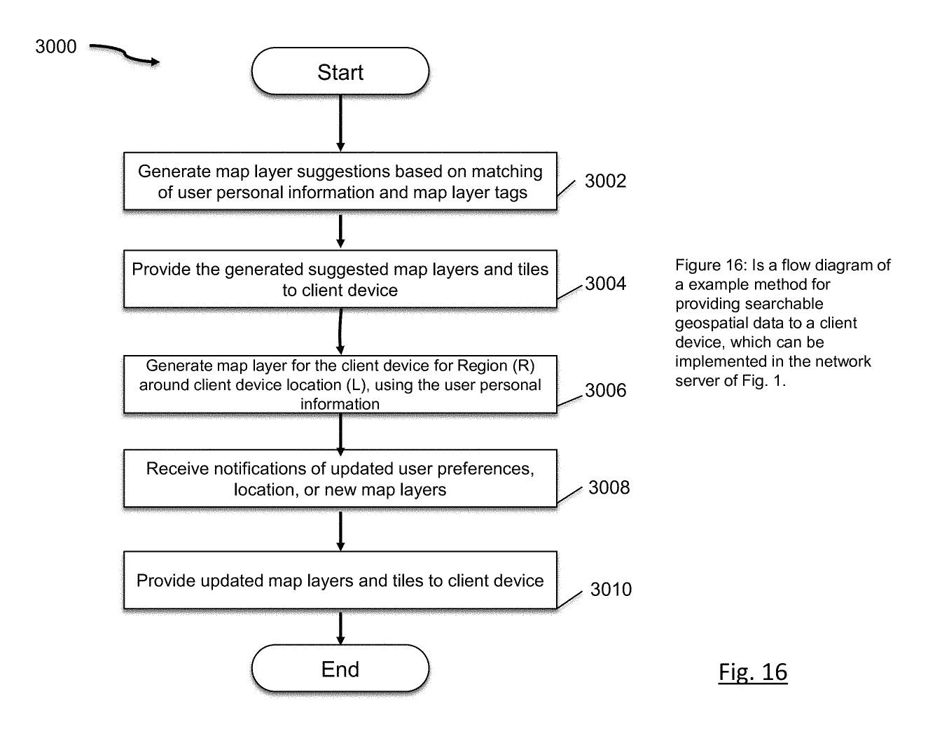

The process for generating suggested/recommended map layers occurs through a matching process performed by the map layer selection engine 1140 in the network server 2012 and may be based on a tagging process, a flow chart of which is shown at 3000, in FIG. 16. Each map layer is associated with one or more map layers through matched tags. The more tags that are matched between map layers, the stronger the “match” or correlation between those map layers. In an embodiment and method of the invention, map layers are suggested in sequential order starting with the highest match rating through to the lowest match rating. The strongest match of a map layer to a user is found based on the user's user personal information (in the user's user profile) and then all of the other map layers are found because they are associated with the suggested map layer. The matched map layer and associated recommended layers are indexed and stored in the geospatial map server, in sequential order of the highest match rating to the lowest match rating, of the recommended map layers. It is understood that this is merely one way of identifying suggested map layers and other manners of doing the same are contemplated.”

In accordance with a method of the invention, generating the suggested map layers occurs through a matching process performed by a map layer selection engine of the geospatial map server based on the user personal information and a map layer tagging system. The tagging process each map layer is matched with associated with one or more other map layers, through use of matched tags, and the larger number of matched tags between a map layer and the one or more map layers, is indicative of a stronger correlation therebetween. Map layers are suggested in sequential order, in an exemplary method, such as starting with a highest match rating to a lowest match rating, wherein the map layer with the highest match rating is identified based on the user personal information associated with the user and the other map layers are identified based on their association with the suggested map layer. That is, the user personal information, saved in a database by the server 12, such as the database 14, is used to generate a suggested map layer list. This map layer list is deployed to the client device and shows up as the map layer catologue in the client device interface.

The process of performing the match is performed by the server 12 by using all of the available user personal information, in the database, and querying it against all of the available (saved) map layers in the database. Clearly, the user personal information of all available map layers in the database are compared against the user personal information provided by the client device. This comparison does not necessarily yield a two state result, such as available/not available, and rather tries to find map layers that are close. That is, in accordance with the process discussed above about matching, the strongest matched map layers are identified and the identified map layers are used to generate the suggested map layer list. Following the creation of map layer catalogue from the suggested map layers deployed to the client device, when a user selects the suggested map layers for viewing, the tiling process is initiated as previously described. The client device requests tiles through the use of its cache memory (cache 1010 in FIG. 13) associated with the suggested map layers.

It is noted that the request transmitted by the client device includes user personal information as well as client device location. Execution of the request results in deployed tiles to the client interface which builds custom maps based on the user's interests and personal data around region (R) at location (L).

Accordingly, map layers are suggested, in sequential order, for instance, starting with a highest match rating to a lowest match rating, where the map layer with the highest match rating is identified as one of the suggested map layers based on the user personal information of the user and all available map layers, as described above. It is contemplated that other tagging and matching processes may be employed without departing from the scope and spirit of the invention.

Only those map layers that are recommended to a user are deployed to the client device, this may be a subset of the generated map layers. Thereafter, when a user engages one of the suggested/recommended map layers through the client interface 2016 (shown in FIG. 14), the engagement initiates one of the various methods of the tiling process, as previously described. Tiles from the suggested map layers form a map layer around the region R in the client device L.

Lastly, the mapping application 1020 deploys searchable map tiles for the region R at the client device location L to the client interface 2016.

FIG. 15 shows a conceptual block and timing flow of an exemplary method of the invention. In the process 2500, of FIG. 15, in summary, the network server 12 provides updated suggested map layers to the client device based on the input of new map layers and/or updated personal information by the user. This occurs, for example, when the user changes their preferences.

More specifically, personal information of the user is queried between the client interface 2016 and the server 2012 using the map layer query engine 1022 of the mapping application 1020, as earlier discussed. Updated user information, at 2504, in FIG. 15, is used when the user takes an action that affects its user profile. Similarly, on the server 2012's end, map layer catalogue is updated, as previously discussed.

As in FIG. 14, the server 2012 executes a search for finding a match with the user of the suggested map layers, further discussed relative to FIG. 16. The map layer query engine 1022 of the mapping application 1020 sends a request to the server 2012, next. This is followed by the server 2012 executing a query, for suggested map layers, of the map layer indexing engine 1021 of the mapping application 1020. Upon receipt of this request, the map layer indexing engine 1021 re-indexes the map layer suggestions.

Next, the client device 1000, and more specifically the geographic query engine 1026, queries the geospatial map server for the necessary tiles to render the geospatial map layer at region (R) around device location L. The server 2012 deploys geospatial tiles for the region R to the client device mapping application 1084. The map tile indexing engine 1028, of the mapping application 1020, re-indexes the geospatial data and stores the same in the cache 1010. The user then queries, from the client interface 2016, the updated results for the map tiles deployed by the server 2012 for region R at the client device location L device, from the map layer assembly engine 1030. The indexing engine functions to store and organize the tiles in client device cache memory. The assembly engine takes those tiles and puts them together to form a map layer around region R. As the device location changes, or the desired location of interest on the client interface changes, the region R updates and which initiates an update to the tiling process in which new tiles are requested and assembled around the new region R.

FIG. 16 shows a flowchart of the process 3000 for providing searchable geospatial data to a client device, in accordance with a method of the invention. The steps of process 3000 are generally performed by the geospatial map server, such as the server 12. At 3002, map layer suggestions (also referred to herein as “suggested map layer(s)) are generated through a matching process using the user personal information, as previously discussed and shown and that is further discussed relative to FIG. 17. Stated differently, at 3002, map layer suggestions are generated, by the server 12, by matching user personal information against the map layer database (library), such as the database 14, to create a list of suggested map layers that are ultimately deployed to the client device.

Next, at 3004, the generated suggested map layers and tiles, generated by the geospatial server 12, are deployed to the client device through the communication network. Next, at 3006, map layer and map tiles, from the suggested map layers and tiles, are generated around the region R, at location L, and assembled by the client device. Accordingly, the client device identifies a map layer, among the generated suggested map layers, for the region (R) around the location (L) of the client device, using the user personal information. At 3008, the network server 12 receives notification of updates to the user personal information, such as user preferences, location, or new map layers being added to the database. This process initiates step 3010 during which the geospatial server 12 updates the suggested map layers using the matching process, discussed above, and deploys an updated map layer and associated tiles to the client device, accordingly.

FIG. 17 shows a flow chart of the method 3500 for adding new map layers to an indexed and searchable map layer database, in a network server, which can be deployed to the client device. At 3502, searchable map layers are received and organized into a map layer database by the network server 12, next at 3504, a new map layer, from 3502, is added to the database, such as the database 14. Subsequently, at 3506, a tagging criteria is added to the new map layer (of 3504). Next, at 3508, the tagging criteria is added to a master list containing all tags used for the map layers. Next at 3560, a determination is made as to whether or not, there are more tags and if so, the process goes back to 3506 and continues from there. Otherwise, the process moves onto 3562 where a determination is made as to whether or not additional map layers are found and if so, the process moves onto 3504 and continues from there, otherwise, the process ends.

Accordingly, the process 3500 outlines the steps for building and updating a suggested map layer database. Indexed and searchable map layers, at 3502, are made available to the network server 12. New map layers are introduced to the catalogue, at 3504. Tags are created for the new map layer at 3506. The new tags are added to a table list, at 3508, to provide a match, correlation, or a relationship function between map layers, as further discussed above. Map layer suggestions are made, to the user (client device), using a matching process between a combination of user personal information with tagged map layers. New map layers can be suggested by the process of adding new tags, at 3560 and/or new map layers, at 3562.

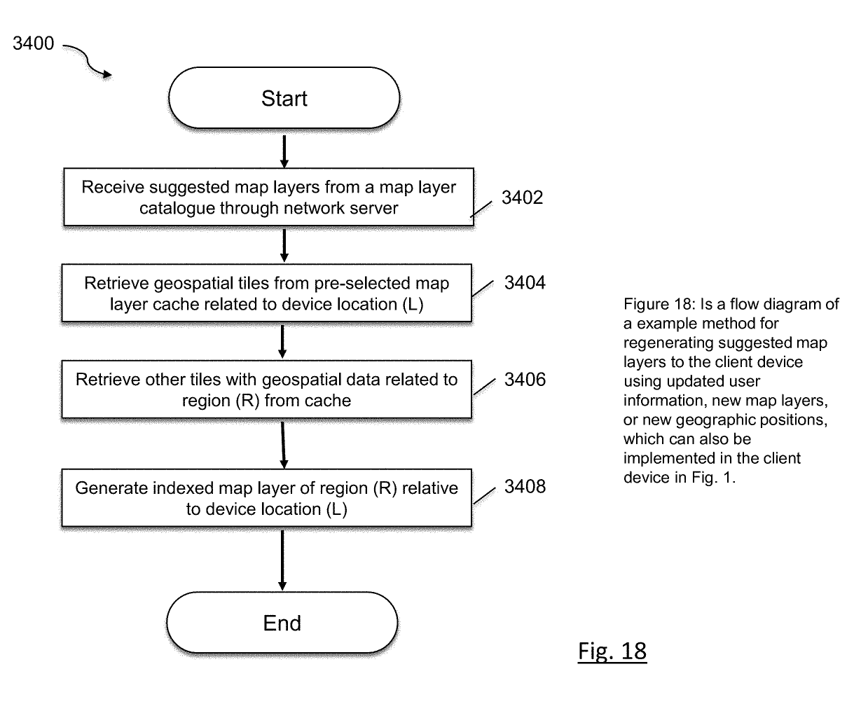

FIG. 18 shows a flow chart of the method 3400 for regenerating suggested map layers to the client device using updated user information, new map layers, or new geographic positions, which can also be implemented in the client device. At 3402, the client device receives suggested map layers from the geospatial map server, through the communication network, from a map layer database. Next, at 3404, the geospatial tiles from a pre-selected map layer (residing in cache) that are associated with the client device location L, is retrieved. In other words, the device would generate a map layer of region R around location (L) using the geospatial tiles defined by the coordinates that of region R.

Next, at 3406, other tiles that have geospatial data related to the region R are retrieved from the cache of the client device. Finally, at 3408, the indexed map layer for the region R, relative to the client device location L, is generated using the retrieved geospatial tiles from 3404 and the retrieved other tiles from 3406.

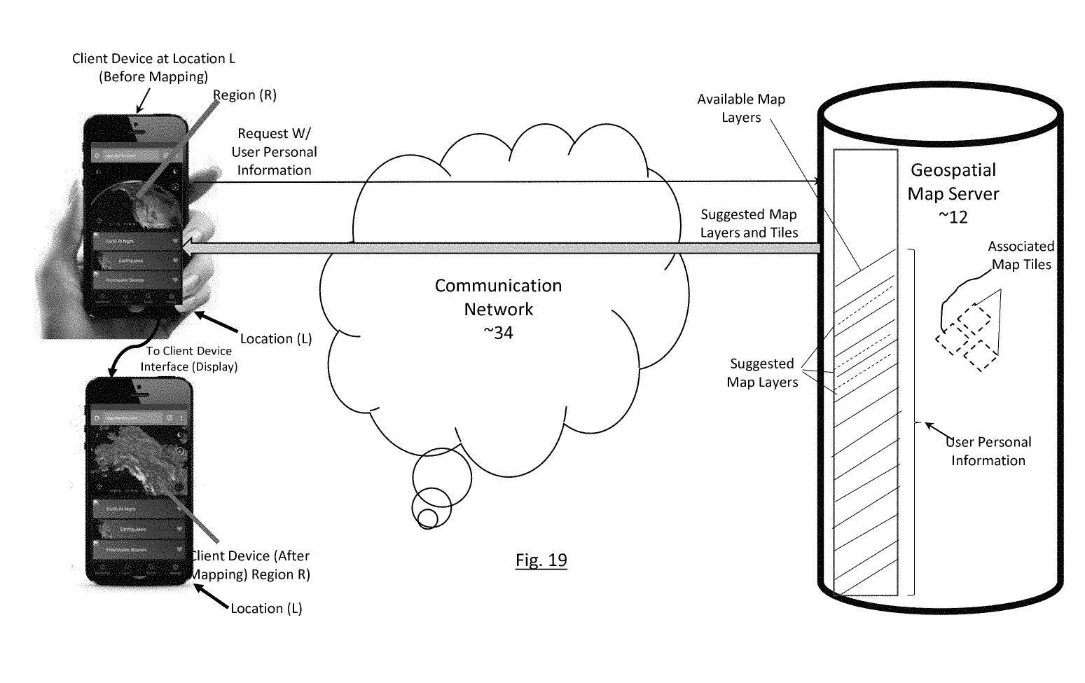

FIG. 19 shows, in conceptual form, a geospatial map system 4000, in accordance with an embodiment and method of the invention. FIG. 19 summarizes some of the interactions discussed previously relative to prior figures and the communication loop formed from the time a request is sent by the client device through the change in the display of the client device in light of the mapping information the client device receives from the server.

The system 4000 is shown to include the client device 32 (of a prior figure), the communication network 34 (from a prior figure), and the geospatial map server 12 (from a prior figure). The client device 32 is shown in two different places in FIG. 19, one location is at the top of the figure, which shows the client device 32 before the request is sent to the server 12 and the bottom of the figure shows the same client device 32 after the mapping information is received from the server 12.

At the top of the figure, the client device 32 is shown displaying (through its client interface, as previously shown and discussed) a region (R) 4004. The client device 32 is shown located at location (L) 4016. A request is made at 4004 where, along with the request, personal information is transmitted from the client device 32 to the server 12. As previously discussed, the next series of actions need not start by the client device sending an express request and can rather be done using alternate methods, as previously noted. The request and personal information are sent through the communication network 34 to the server 12.

Upon receipt of the request and personal information, the server 12 searches among its available map layers 4002 and using the user personal information 4016 received from the client device 32, and locates suggested map layers 4012 and associated map tiles 4014. Next, the suggested map layers and associated map tiles are transmitted, through the communication network 34, to the client device 32.

As previously noted, the bottom figure shows the client device 32, after receipt of the mapping information from the server 12. The location (L) 4016, of the client device 32, remains substantially the same as it was prior to the sending of the request. The region (R) also remains substantially the same but the display of the client device 32 changes. The sequence of events, in summary, is as follows: (1) A user selects one or more of the pre-suggested map layer(s) in the catalogue; (2) the pre-suggested map layer(s) is tiled which forms the map layer in the region (R); (3) the user changes the screen view by zooming in/out or changing (physical) location, effectively changing the location (L) of the client device; and (4) the map layer is re-tiled in response to those interface changes.

It is noted that the tiling process is constant. The client device is continually re-tiling based on new information from the client device. These changes include different regions (R) and/or different locations (L). For example shown in the two clients in FIG. 19 are different regions. The top is zoomed out and the bottom is zoomed in. This would result in different regions being mapped. If the globe was zoomed embodiments thereof, these particular embodiments are merely illustrative, and over to say London, this would change the location and thus the new location would be tiled.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time.

Particular embodiments may be implemented in a computer-readable storage medium for use by or in connection with the instruction execution system, apparatus, system, or device. Particular embodiments can be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Although the description has been described with respect to particular not restrictive.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

Thus, while particular embodiments have been described herein, latitudes of modification, various changes, and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit.

What we claim is:

1. A method of geospatial mapping comprising:
upon formation of a user account with user personal information from which a map layer catalogue of suggested map layers is formed, receiving, from a client device, a request for map tiles for those suggested map layers, generated by a geospatial map server, via a communication network, the received request including a location of the client device, the user personal information including the location of the client device, and the map layer catalogue including the suggested map layers generated from the user personal information;
a geospatial and visualization device generating the suggested map layers and the map tiles; and
a map layer deployment engine of the geospatial map server deploying the map tiles, through the communication network, to the client device, the deployed map tiles being a part of the generated map tiles representing pre-defined geographic boundaries of a region (R) surrounding the location (L) of the client device, the region R defined by boundaries of an area of a display of the client device employed by a user of the client device.

2. The method of geospatial mapping of claim 1, wherein suggested map layers previously deployed to the client device are maintained in one or more previous map layer catalogues by the client device.

3. The method of geospatial mapping of claim 1, wherein only a subset of the available map layers in the database are matched to the user personal information and deployed to the client device and maintained as a part of the map layer catalogue by the client device.

4. The method of geospatial mapping of claim 1, further including the generation of the suggested map layers occurs through a matching process performed by a map layer selection engine of the geospatial map server based on the user personal information and a map layer tagging system.

5. The method of geospatial mapping of claim 4, wherein the map layer tagging process matches each map layer associated with one or more other map layers through use of matched tags, with a larger number of matched tags between a map layer and the one or more map layers, is indicative of a stronger correlation therebetween.

6. The method of geospatial mapping of claim 5, wherein the map layers are suggested in sequential order starting with a highest match rating to a lowest match rating, wherein the map layer with the highest match rating is identified based on the user personal information, associated with the user, among the available map layers based on their user personal information.

7. The method of geospatial mapping of claim 1, wherein the request from the client device is an express request for map tiles or the request is implied by the formation of the user personal account.

8. The method of geospatial mapping of claim 1, further including the user selecting a map layer in the map layer catalogue, initiating a map tiling request to the geospatial map server thereby causing the map tiles to be deployed to the client device and stored in a cache memory thereof.

9. The method of geospatial mapping of claim 1, wherein the user personal information includes at least the location of the client device and date of birth, location, gender, and personal interests of the user.

10. The method of geospatial mapping of claim 1, further including determining the location of the client device through use of a global positioning system (GPS).

11. The method of geospatial mapping of claim 1, wherein the map tiles are stored in a cache memory of the client device and deployed to the client device, wherein the map tiles are defined by the region R at a geographic location (L) of the client device and wherein the region R is defined by geographic boundaries of an area of the display, selected by the user.

12. The method of geospatial mapping of claim 11, wherein the map tiles are deployed to the area selected by the user, based on the user's personal information.

13. A geospatial mapping system comprising:
a geospatial map server coupled to a client device through a communication network, the geospatial map server including,
a map layer sequencing engine that upon formation of a user account with user personal information from which a map layer catalogue is formed, is configured to receive, from the client device, a request for map tiles comprising suggested map layers, the received request including a location of the client device, the map layer catalogue including the suggested map layers generated from the user personal information and available map layers in a database;
a geospatial and visualization device configured to generate the suggested map layers and the map tiles; and
a map layer deployment engine coupled to the map layer sequencing engine configured to deploy the generated map tiles to the client device, the deployed map tiles being a part of the generated map tiles and representing pre-defined geographic boundaries of a region (R) surrounding the location (L) of the client device, the region R defined by boundaries of an area of a display of the client device employed by a user of the client device.

14. The geospatial mapping system of claim 13, wherein suggested map layers previously deployed to the client device are maintained in one or more previous map layer catalogues by the client device.

15. The geospatial mapping system of claim 13, wherein the map layer sequencing engine is configured to match only a subset of the available map layers, saved in the database, to the user personal information, the subset of the available map layer being deployed to the client device as the suggested map layers for storage as a part of the map layer catalogue, by the client device.

16. The geospatial mapping system of claim 13, wherein the map layer selection engine is configured to generate the suggested map during a matching process based on the user personal information and a map layer tagging system.

17. The geospatial mapping system of claim 16, wherein the map layer tagging process is configured to match each map layer associated with one or more other map layers through use of matched tags, with a larger number of matched tags between a map layer and the one or more map layers being indicative of a stronger correlation therebetween.

18. The geospatial mapping system of claim 13, wherein the request from the client device is an express request for map tiles or the request is implied by the formation of the user personal account.

19. The geospatial mapping system of claim 13, wherein a selection is made by the user of a map layer in the map layer catalogue, upon the initiation of the map tiling request to the geospatial map server thereby causing the map tiles to be deployed to the client device by the map layer deployment engine and stored in a cache memory of the client device.

20. The geospatial mapping system of claim 13, wherein the user personal information includes at least the location of the client device and date of birth, location, gender, and personal interests of the user.

21. The geospatial mapping system of claim 13, further including determining the location of the client device through use of a global positioning system (GPS).

22. The geospatial mapping system of claim 13, wherein the map tiles are stored in a cache memory of the client device after being deployed to the client device, the map tiles are defined by the region R at the location (L) of the client device and wherein the region R is defined by geographic boundaries of an area of the display that is selected by the user.

23. The geospatial mapping system of claim 22, wherein the map tiles are deployed to the area selected by the user based on the user personal information.

24. A computer-readable storage medium comprising encoded logic for execution by the one or more computer processors, the logic when executed is operable to:
upon formation of a user account with user personal information from which a map layer catalogue is formed, receiving, from a client device, a request for map tiles comprising suggested map layers generated by a geospatial map server, via a communication network, the received request including a location of the client device, the user personal information including the location of the client device, the map layer catalogue including the suggested map layers generated from the user personal information and available map layers in a database;
a geospatial and visualization device generating the suggested map layers and the map tiles; and
a map layer deployment engine of the geospatial map server deploying the map tiles, through the communication network, to the client device, the deployed map tiles being a part of the generated map tiles representing pre-defined geographic boundaries of a region (R) surrounding the location (L) of the client device, the region R defined by boundaries of an area of a display of the client device employed by a user of the client device.

25. The computer-readable storage medium of claim 24, wherein suggested map layers previously deployed to the client device are maintained in one or more previous map layer catalogues by the client device.

26. The computer-readable storage medium of claim 24, wherein only a subset of the available map layers in the database are matched to the user personal information and deployed to the client device and maintained as a part of the map layer catalogue by the client device.

27. The computer-readable storage medium of claim 24, further including the generating the suggested map layers occurs through a matching process performed by a map layer selection engine of the geospatial map server based on the user personal information and a map layer tagging system.

28. The computer-readable storage medium of claim 27, wherein the map layer tagging process matches each map layer associated with one or more other map layers through use of matched tags, with a larger number of matched tags between a map layer and the one or more map layers, is indicative of a stronger correlation therebetween.

29. The computer-readable storage medium of claim 24, wherein the request from the client device is an express request for map tiles or the request is implied by the formation of the user personal account.

30. The computer-readable storage medium of claim 24, further including the user selecting a map layer in the map layer catalogue, initiating a map tiling request to the geospatial map server thereby causing the map tiles to be deployed to the client device and stored in a cache memory thereof.

31. The computer-readable storage medium of claim 24, wherein the user personal information includes at least the location of the client device and date of birth, location, gender, and personal interests of the user.

32. The computer-readable storage medium of claim 24, further including determining the location of the client device through use of a global positioning system (GPS).

33. The computer-readable storage medium of claim 24, wherein the map tiles are stored in a cache memory of the client device and deployed to the client device, wherein the map tiles are defined by the region R at a geographic location (L) of the client device and wherein the region R is defined by geographic boundaries of an area of the display, selected by the user.

34. The computer-readable storage medium of claim 33, wherein the map tiles are deployed to the area selected by the user, based on the user personal information.

35. The computer-readable storage medium of claim 24, wherein upon a change to the user personal information, updated suggested map layers and tiles are generated.
